(19) United States
(12) Patent Application Publication
(10) Pub. No.: US 2024/0042544 A1
(43) Pub. Date: Feb. 8, 2024

(54) LASER DEVICE AND ELECTRONIC DEVICE MANUFACTURING METHOD

(71) Applicant: GIGAPHOTON INC., Tochigi (JP)

(72) Inventor: Takuma YAMANAKA, Oyama-shi (JP)

(73) Assignee: GIGAPHOTON INC., Tochigi (JP)

(21) Appl. No.: 18/482,512

(22) Filed: Oct. 6, 2023

Related U.S. Application Data
(63) Continuation of application No. PCT/JP2021/019367, filed on May 21, 2021.

(51) Int. Cl. B23K 26/0622; B23K 26/06

(52) U.S. Cl. CPC B23K 26/0622; B23K 26/0643; B23K 26/0652; B23K 2101/36

(57) ABSTRACT

A laser device includes an oscillator outputting pulse laser light, a wavelength monitor measuring a center wavelength of the pulse laser light, and a processor. The oscillator includes a chamber including discharge electrodes applying a voltage to a laser gas in the chamber, an optical element arranged on an optical path of the pulse laser light, a drive mechanism driving a rotation stage on which the optical element is mounted, a grating, and an output coupling mirror. The processor periodically switches a target value of the center wavelength, controls the center wavelength by outputting a drive command to the drive mechanism to change an incident angle on the grating, and corrects a drive command value of the drive mechanism for outputting the pulse laser light with the same target value in a subsequent cycle based on a deviation between a measurement value of the center wavelength and the target value.

### CROSS-REFERENCE TO RELATED APPLICATIONS

The present application claims the benefit of International Application No. PCT/JP2021/019367, filed on May 21, 2021, the entire contents of which are hereby incorporated by reference.

### BACKGROUND

### 1. Technical Field

The present disclosure relates to a laser device and an electronic device manufacturing method.

### 2. Related Art

Recently, in a semiconductor exposure apparatus, improvement in resolution has been desired for miniaturization and high integration of semiconductor integrated circuits. For this purpose, an exposure light source that outputs light having a shorter wavelength has been developed. For example, as a gas laser device for exposure, a KrF excimer laser device for outputting laser light having a wavelength of about 248 nm and an ArF excimer laser device for outputting laser light having a wavelength of about 193 nm are used.

The KrF excimer laser device and the ArF excimer laser device each have a large spectral line width of about 350 to 400 pm in natural oscillation light. Therefore, when a projection lens is formed of a material that transmits ultraviolet rays such as KrF laser light and ArF laser light, there is a case in which chromatic aberration occurs. As a result, the resolution may decrease. Then, a spectral line width of laser light output from the gas laser device needs to be narrowed to the extent that the chromatic aberration can be ignored. For this purpose, there is a case in which a line narrowing module (LNM) including a line narrowing element (etalon, grating, and the like) is provided in a laser resonator of the gas laser device to narrow a spectral line width. In the following, a gas laser device with a narrowed spectral line width is referred to as a line narrowing gas laser device.

### LIST OF DOCUMENTS

### Patent Documents

Patent Document 1: US Patent Application Publication No. 2016/0299441

### SUMMARY

A laser device according to an aspect of the present disclosure includes an oscillator configured to output pulse laser light in a burst form, a wavelength monitor configured to measure a center wavelength of the pulse laser light output from the oscillator, and a processor. Here, the oscillator includes a chamber including discharge electrodes configured to apply a voltage to a laser gas in the chamber, an optical element arranged on an optical path of the pulse laser light, a rotation stage on which the optical element is mounted, a drive mechanism configured to rotate the optical element by driving the rotation stage, a grating on which the pulse laser light transmitted through or reflected by the optical element is incident, and an output coupling mirror configured to output the pulse laser light. The processor is configured to periodically switch a target value of the center wavelength of the pulse laser light between a first target value and a second target value different from the first target value, control the center wavelength, based on the target value and a measurement value of the center wavelength measured by the wavelength monitor, by outputting a drive command to the drive mechanism to change an incident angle of the pulse laser light on the grating, and correct a drive command value of the drive mechanism for outputting the pulse laser light with the same target value in a subsequent cycle based on a deviation between the measurement value of the center wavelength and the target value.

An electronic device manufacturing method according to an aspect of the present disclosure includes generating laser light using a laser device, outputting the laser light to an exposure apparatus, and exposing a photosensitive substrate to the laser light in the exposure apparatus to manufacture an electronic device. Here, the laser device includes an oscillator configured to output pulse laser light in a burst form, a wavelength monitor configured to measure a center wavelength of the pulse laser light output from the oscillator, and a processor. The oscillator includes a chamber including discharge electrodes configured to apply a voltage to a laser gas in the chamber, an optical element arranged on an optical path of the pulse laser light, a rotation stage on which the optical element is mounted, a drive mechanism configured to rotate the optical element by driving the rotation stage, a grating on which the pulse laser light transmitted through or reflected by the optical element is incident, and an output coupling mirror configured to output the pulse laser light. The processor is configured to periodically switch a target value of the center wavelength of the pulse laser light between a first target value and a second target value different from the first target value, control the center wavelength, based on the target value and a measurement value of the center wavelength measured by the wavelength monitor, by outputting a drive command to the drive mechanism to change an incident angle of the pulse laser light on the grating, and correct a drive command value of the drive mechanism for outputting the pulse laser light with the same target value in a subsequent cycle based on a deviation between the measurement value of the center wavelength and the target value.

### BRIEF DESCRIPTION OF THE DRAWINGS

Embodiments of the present disclosure will be described below merely as examples with reference to the accompanying drawings.

FIG. 1 schematically shows an exemplary configuration of a laser device.

FIG. 2 is a graph showing an example of wavelength commands which are periodically switched and actual wavelengths of pulse laser light output due to the wavelength control according to a comparative example.

FIG. 3 is a graph showing an example of an output target of the spectrum and the actually output spectrum.

FIG. 4 is a timing chart showing an example of the operation of the laser device according to a first embodiment.

FIG. 5 is a flowchart showing a control example of the laser device according to the first embodiment.

FIG. 6 is a control block diagram of the laser device according to the first embodiment.

FIG. 7 is a timing chart showing an example of the operation of the laser device according to a second embodiment.

FIG. 8 is a flowchart showing a control example of the laser device according to the second embodiment.

FIG. 9 schematically shows the configuration of an exposure apparatus.

### DESCRIPTION OF EMBODIMENTS

### <Contents>

1. Overview of laser device

1.1 Configuration

1.2 Operation

### 2. Problem

### 3. First Embodiment

3.1 Configuration

3.2 Operation

3.3 Description of flowchart showing control example

3.4 Description of control block diagram

3.5 Effect

### 4. Second Embodiment

4.1 Configuration

4.2 Operation

4.3 Description of flowchart showing control example

4.4 Effect

5. Electronic device manufacturing method

### 6. Others

Hereinafter, embodiments of the present disclosure will be described in detail with reference to the drawings. The embodiments described below show some examples of the present disclosure and do not limit the contents of the present disclosure. Also, all configurations and operation described in the embodiments are not necessarily essential as configurations and operation of the present disclosure. Here, the same components are denoted by the same reference numeral, and duplicate description thereof is omitted.

### 1. Overview of Laser Device

### 1.1 Configuration

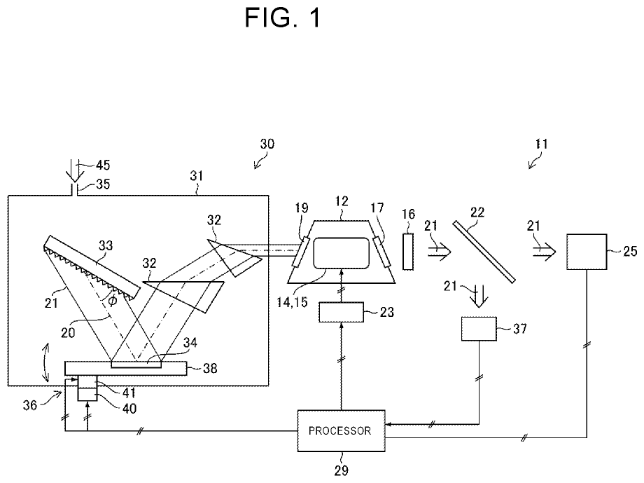

FIG. 1 schematically shows an exemplary configuration of a laser device 11. The laser device 11 is an excimer laser device including a laser chamber 12 in which a laser gas as a laser medium is filled. At both ends of the laser chamber 12, a front window 17 and a rear window 19 through which pulse laser light 21 is transmitted are arranged via holders (not shown).

Inside the laser chamber 12, a pair of discharge electrodes 14, 15 are arranged so as to face each other in a direction perpendicular to the paper surface of FIG. 1. A high voltage is applied between the discharge electrodes 14, 15 from a high voltage power source 23, and pulse discharge occurs to excite the laser gas, thereby generating the pulse laser light 21 at a frequency of, for example, several kHz to ten or more kHz.

For example, the generated pulse laser light 21 travels to the rear side of the laser chamber 12 (the left side in FIG. 1), and enters a line narrowing unit 30 that line narrows the pulse laser light 21. The line narrowing unit 30 is surrounded by a line narrowing box 31, and includes therein, as optical elements, prisms 32, 32, a wavelength selection mirror 34, a grating 33, and the like.

A purge gas supply port 35 is provided in the wall of the line narrowing box 31. A purge gas 45 having low reactivity such as high-purity nitrogen or a dry rare gas is introduced into the line narrowing box 31 through the purge gas supply port 35.

The pulse laser light 21 having entered the line narrowing unit 30 is enlarged by the prisms 32, 32, is reflected by the wavelength selection mirror 34, and is incident on the grating 33 that is a line narrowing optical element. On the grating 33, only the pulse laser light 21 having a center wavelength λc determined by an incident angle φ is reflected by diffraction. That is, the grating 33 is arranged in a Littrow arrangement so that, among the incident pulse laser light, diffracted light having the center wavelength λc corresponding to the incident angle φ returns to the laser chamber 12.

The wavelength selection mirror 34 is mounted on a movable holder 36 which is rotatable in a horizontal plane (in a plane parallel to the paper surface of FIG. 1). The wavelength selection mirror 34 is arranged on the optical path between the prism 32 and the grating 33, and the incident angle φ of the pulse laser light 21 incident on the grating 33 is changed by rotating the movable holder 36 to rotate the wavelength selection mirror 34. Thus, the center wavelength λc of the pulse laser light 21 diffracted by the grating 33 is changed. Here, in FIG. 1, the reference numeral 20 represents a laser light axis of the pulse laser light 21.

The line narrowed pulse laser light 21 is amplified by the discharge between the discharge electrodes 14, 15 while reciprocating several times between the grating 33 in the line narrowing unit 30 and an output coupling mirror 16 which partially reflects the pulse laser light 21. Then, the light is partially transmitted through the output coupling mirror 16, is output forward (to the right in FIG. 1) as the pulse laser light 21, and enters the exposure apparatus 25. A part of the output pulse laser light 21 is extracted downward in FIG. 1 by a beam splitter 22, and the center wavelength λc thereof is monitored by a wavelength monitor 37.

The movable holder 36 includes a rectangular mirror holder 38 to which the wavelength selection mirror 34 is fixed. The mirror holder 38 is attracted to the line narrowing box 31 by an urging force of an extension spring (not shown) and a plate spring (not shown).

Further, among the four corners of the mirror holder 38, a first corner portion and a second corner portion are pressed from the line narrowing box 31 by a manual micrometer (not shown) and a support member (not shown), respectively. A piezoelectric element unit 41 is attached to a third corner portion of the mirror holder 38. A front end portion of the piezoelectric element unit 41 is in contact with a ball screw unit (not shown) by the urging force of the extension spring (not shown) and the plate spring (not shown), and presses a stepping motor unit 40. The piezoelectric element unit 41 is a fine motion drive mechanism including a piezoelectric element. The stepping motor unit 40 is a coarse motion drive mechanism including a stepping motor. Hereinafter, the piezoelectric element may simply be referred to as “piezoelectric” or “PZT.”

The stepping motor unit 40 and the piezoelectric element unit 41 are both electrically connected to a processor 29. The processor 29 functions as a laser controller that controls the entire laser device 11. The processor of the present disclosure is a processing device including a storage device in which a control program is stored and a central processing unit (CPU) that executes the control program. The processor 29 is specifically configured or programmed to perform various processes included in the present disclosure.

The stepping motor unit 40 rotates a motor shaft by a predetermined amount in accordance with the number of pulses of the pulse signal received from the processor 29. A rear end portion of a ball screw unit having a precisely processed screw thread is attached to a front end portion of the motor shaft via a coupling. Owing to a guide, the ball screw unit smoothly moves linearly in the front-rear direction while rotating.

A front end portion of the ball screw unit is precisely processed in a plane perpendicular to the longitudinal direction thereof, and the front end portion of the piezoelectric element unit 41 precisely processed into a spherical surface abuts on this plane. Therefore, when the ball screw unit moves back and forth while rotating, the piezoelectric element unit 41 moves back and forth without rotating. A rear end portion of the piezoelectric element unit 41 is fixed to an ultraviolet cover (not shown) fixed to the mirror holder 38.

The wiring of the piezoelectric element unit 41 passes through the inside of the ultraviolet cover, reaches the outside of the line narrowing box 31 through an introduction hole (not shown), and is connected to the processor 29. The piezoelectric element unit 41 expands and contracts in the front-rear direction by a length corresponding to the magnitude of a voltage V applied via the wiring.

A position at about half of the full stroke of the piezoelectric element unit 41 is referred to as a neutral position. The voltage V for expanding the piezoelectric element unit 41 to the neutral position is referred to as a neutral voltage VO. The processor 29 constantly applies the neutral voltage VO to the piezoelectric element unit 41. Thus, the piezoelectric element unit 41 is maintained at the neutral position as the initial position.

The processor 29 outputs a command to the movable holder 36 to expand and contract the stepping motor unit 40 or the piezoelectric element unit 41, thereby pushing and pulling the third corner portion of the mirror holder 38 via the ultraviolet cover. As a result, the wavelength selection mirror 34 is rotated, the incident angle φ is changed, and the center wavelength λc of the pulse laser light 21 is changed.

At this time, the processor 29 performs wavelength control so that the wavelength deviation, which is the difference between the center wavelength λc and the target wavelength, becomes smaller than a predetermined allowable range based on the center wavelength λc monitored by the wavelength monitor 37.

The processor 29 also controls the pulse energy of the pulse laser light 21 by outputting a command to the high voltage power source 23. Further, the processor 29 communicates with the exposure apparatus 25, and causes laser oscillation based on an oscillation command signal from the exposure apparatus 25. Further, there is a case that the processor 29 outputs an oscillation command signal based on its own judgment to cause laser oscillation.

The laser chamber 12 having the discharge electrodes 14, 15, the line narrowing unit 30, the piezoelectric element unit 41, and the output coupling mirror 16 configure an oscillator for outputting the pulse laser light 21.

### 1.2 Operation

It is known that, when a resist film is irradiated with the pulse laser light 21 at the exposure apparatus 25, exposure is performed at a plurality of wavelengths to increase the focal depth. When the focal depth is increased, the imaging performance in the thickness direction of the resist film can be maintained even when the resist film having a large film thickness is exposed.

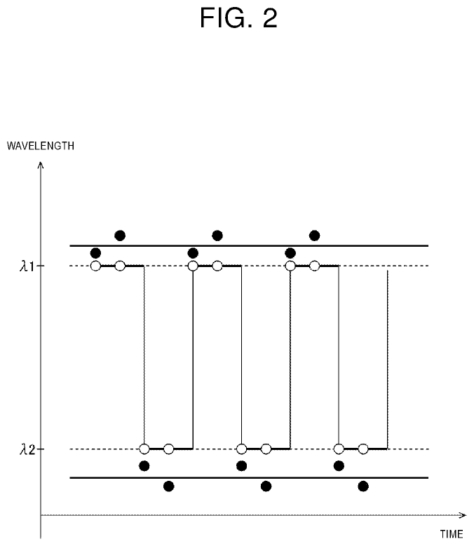

As means for exposing at a plurality of wavelengths, for example, it is known to periodically switch the center wavelength of the pulse laser light 21 generated by the laser device 11 between two wavelengths of a long wavelength and a short wavelength (see FIG. 2). An example of the operation in a case in which a wavelength λ1 and a wavelength λ2 are set as the target wavelength (target value of the center wavelength) and these two wavelengths are periodically switched is as follows.

[Step 1] The processor 29 receives the target wavelengths λ1, λ2 as two wavelengths and a cycle T for controlling the wavelength from the exposure apparatus 25. The cycle T is represented by the number of pulses N in one cycle. The number of pulses N representing the cycle T may be the number of pulses applied to the same portion of the resist film on the wafer, that is, the number of N slit pulses.

[Step 2] The processor 29 drives the piezoelectric element unit 41 or the stepping motor unit 40 to rotate the wavelength selection mirror 34 so as to realize the received target wavelength λ1, and changes the incident angle φ of the pulse laser light 21 incident on the grating 33.

[Step 3] A part of the line narrowed pulse laser light 21 is extracted by the beam splitter 22, and the wavelength thereof is measured by the wavelength monitor 37.

[Step 4] When the measured wavelength (center wavelength λc) is shifted with respect to the target wavelength λ1, the processor 29 drives the piezoelectric element unit 41 having excellent high-speed responsiveness, and adjusts the posture of the wavelength selection mirror 34 so that the center wavelength λc approaches the target wavelength λ1. The feedback control of step 4 is performed for each pulse.

[Step 5] At the timing of switching the wavelengths, the processor 29 drives the piezoelectric element unit 41 to rotate the wavelength selection mirror 34 and changes the incident angle φ of the pulse laser light 21 incident on the grating 33 so that the center wavelength λc of the pulse laser light 21 becomes the target wavelength λ2.

[Step 6] Part of the pulse laser light 21 generated by the operation of step 5 is extracted by the beam splitter 22, and the wavelength thereof is measured by the wavelength monitor 37.

[Step 7] When the measured wavelength is shifted with respect to the target wavelength λ2, the processor 29 drives the piezoelectric element unit 41 and adjusts the posture of the wavelength selection mirror 34 so that the center wavelength λc approaches the target wavelength λ2. The feedback control of step 7 is also performed for each pulse.

[Step 8] At the timing of switching the wavelengths, the processor 29 drives the piezoelectric element unit 41 to rotate the wavelength selection mirror 34 and changes the incident angle φ of the pulse laser light 21 incident on the grating 33 so that the target wavelength λ1 is realized.

Then, the above steps 3 to 8 are repeated. Although an example in which the wavelength selection mirror 34 is rotated has been described with reference to FIG. 1, the wavelength selection mirror 34 may be eliminated, and at least one of the prisms 32, 32 may be rotated to change the incident angle φ of the pulse laser light 21 incident on the grating 33.

### 2. Problem

FIG. 2 is a graph showing an example of wavelength commands which are periodically switched and actual wavelengths of the pulse laser light 21 output under the wavelength control according to the comparative example. The horizontal axis represents time, and the vertical axis represents the wavelength. The comparative example of the present disclosure is an example recognized by the applicant as known only by the applicant, and is not a publicly known example admitted by the applicant.

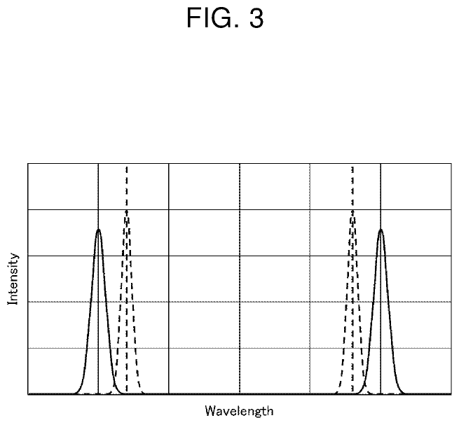

In FIG. 2, a white circle indicates a target wavelength corresponding to a wavelength command value, and a black circle indicates a measurement value of an actual wavelength. FIG. 3 is a graph showing an example of the spectrum (solid line) of the actual pulse laser light 21 generated based on the wavelength command of the two wavelengths of the wavelength λ1 and the wavelength λ2 shown in FIG. 2. The horizontal axis represents the wavelength, and the vertical axis represents the light intensity. The spectral waveform indicated by broken lines show an example of the spectrum in a case in which the pulse laser light 21 is output just as the wavelength command values.

As shown in FIG. 2, when the wavelength command is periodically switched, a wavelength deviation occurs due to the hysteresis characteristic, natural vibration, thermal characteristic variation, and the like of the piezoelectric element, but when the wavelength command is switched at a high speed, the wavelength control of the comparative example including delay cannot follow and the deviation remains. As a result, it is difficult to control the peak interval of the two wavelengths just as the wavelength command (see FIG. 3).

### 3. First Embodiment

### 3.1 Configuration

The configuration of the laser device 11 according to a first embodiment may be similar to that shown in FIG. 1.

### 3.2 Operation

The laser device 11 according to the first embodiment is different from the comparative example in the operation including the control executed by the processor 29. In the following, the operation of the laser device 11 according to the first embodiment will be described in terms of differences from that of the comparative example.

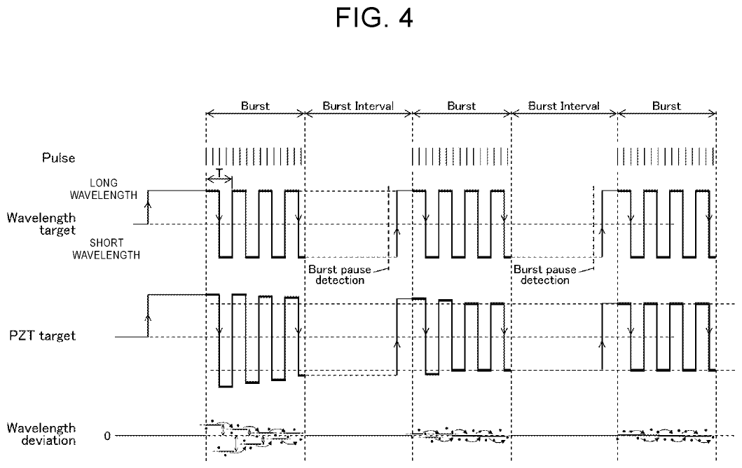

FIG. 4 is a timing chart showing an example of the operation of the laser device 11 according to the first embodiment. The horizontal axis represents time. In the uppermost row of FIG. 4, an example of the pulse oscillation in a burst form by the burst operation is shown, and in the second row, the waveform of the wavelength command for commanding the target wavelength is shown. The third row from the top shows the waveform of the piezo command, which is a drive command given to the piezoelectric element, and the lowermost row shows the difference between the wavelength command and the wavelength actually measured. The deviation of the measurement value of the wavelength from the wavelength command value is referred to as a “wavelength deviation.”

In the waveform of the wavelength command, the command of the wavelength λ1 having a relatively long wavelength and the command of the wavelength λ2 having a relatively short wavelength are switched within the cycle T during the burst period. Although the waveform of the wavelength command is shown as a rectangular wave in FIG. 4, the actual wavelength command is a discrete graph that commands the target wavelength for each pulse. That is, the processor 29 switches, in a rectangular wave shape, between the wavelength command in which a plurality of pulses having the target wavelength of λ1 being a long wavelength are continuous and the wavelength command in which a plurality of pulses having the target wavelength of λ2 being a short wavelength are continuous. FIG. 4 exemplifies a waveform of a rectangular-wave-shaped wavelength command in which the wavelength command of the long wavelength and the wavelength command of the short wavelength each have two continuous pulses.

The target wavelength periodically switched between the wavelength λ1 and the wavelength λ2 is an example of the “target value” in the present disclosure. The wavelength λ1 is an example of the “first target value” in the present disclosure, and the wavelength λ2 is an example of the “second target value” in the present disclosure. The cycle T for switching the wavelength command is an example of the “wavelength change cycle” in the present disclosure. In the present disclosure, the cycle T may be referred to as a “rectangular cycle.”

In the waveform of the piezo command, the piezo command value periodically changes in accordance with the switching of the command between the wavelength λ1 and the wavelength λ2.

The processor 29 stores, in a memory, the wavelength deviation for each pulse or the average value of the wavelength deviation (in the case of FIG. 4, the average value of two continuous pulses) in each wavelength command for the rectangular cycle. Then, the processor 29 adjusts the piezo command value of the next rectangular cycle based on the stored wavelength deviation or the average value of the wavelength deviation. The term “adjust” includes the concept of “correct.” The “next rectangular cycle” is an example of the “subsequent cycle” in the present disclosure.

The adjustment amount (correction amount) of the piezo command value based on the wavelength deviation or the average value of the wavelength deviation is preferably a value obtained by multiplying the wavelength deviation or the average value of the wavelength deviation by a coefficient smaller than 1 to maintain the stability of the wavelength control. The coefficient is a learning control coefficient, and is preferably in a range of 0.01 to 0.5, and more preferably in a range of 0.05 to 0.5. The adjustment amount of the piezo command value calculated using the learning control coefficient is referred to as a “piezo command correction amount.”

A black dot shown in the graph indicating the waveform of the wavelength deviation shown in the lowermost row of FIG. 4 indicates the wavelength deviation measured for each pulse, and the average values of the wavelength deviation of two continuous pulses corresponding to the wavelength commands of the long wavelength and the short wavelength in the cycle T are shown in a graph format. By repeating the correction control of the piezo command values of the long wavelength and the short wavelength for each cycle T of the wavelength command, the wavelength deviation gradually decreases.

Shown here is an example in which two pulses of the pulse laser light 21 according to the wavelength command of the long wavelength are continuously output and two pulses of the pulse laser light 21 according to the wavelength command of the short wavelength are continuously output in the cycle T. However, two or more pulses of the pulse laser light 21 may be continuously output for each wavelength command. The two continuous pulses in the wavelength command of the long wavelength correspond to an example of the “first pulse number” in the present disclosure, and the two continuous pulses in the wavelength command of the short wavelength correspond to an example of the “second pulse number” in the present disclosure.

Using the piezo command correction amount for each target wavelength calculated in a preceding first cycle of the rectangular cycle, the piezo command value of the same target wavelength in a subsequent second period is corrected. When n is an integer of 1 or more, the piezo command value of the n-th pulse in the second cycle is corrected based on the wavelength deviation of the n-th pulse in the first cycle.

### 3.3 Description of Flowchart Showing Control Example

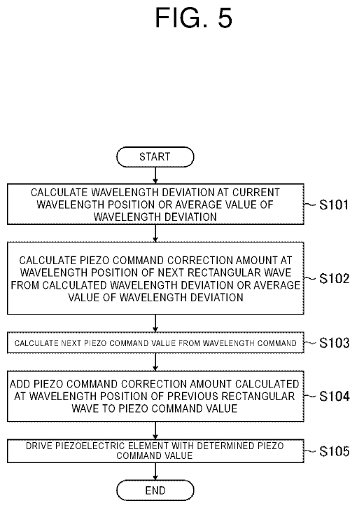

FIG. 5 is a flowchart showing a control example of the laser device 11 according to the first embodiment. When the flowchart of FIG. 5 is started, in step S101, the processor 29 calculates the wavelength deviation at the present wavelength position or the average value of the wavelength deviation.

In step S102, the processor 29 calculates the piezo command correction amount at the wavelength position of the next rectangular wave from the calculated wavelength deviation or the average value of the wavelength deviation.

In step S103, the processor 29 calculates the next piezo command value from the wavelength command.

In step S104, the processor 29 adds the piezo command correction amount calculated at the wavelength position of the previous rectangular wave to the piezo command value obtained in step S103.

In step S105, the processor 29 drives the piezoelectric element with the piezo command value determined in step S104.

After step S105, the processor 29 ends the flowchart of FIG. 5. The processor 29 repeatedly executes the flowchart of FIG. 5 during the burst period of the burst operation.

### 3.4 Description of Control Block Diagram

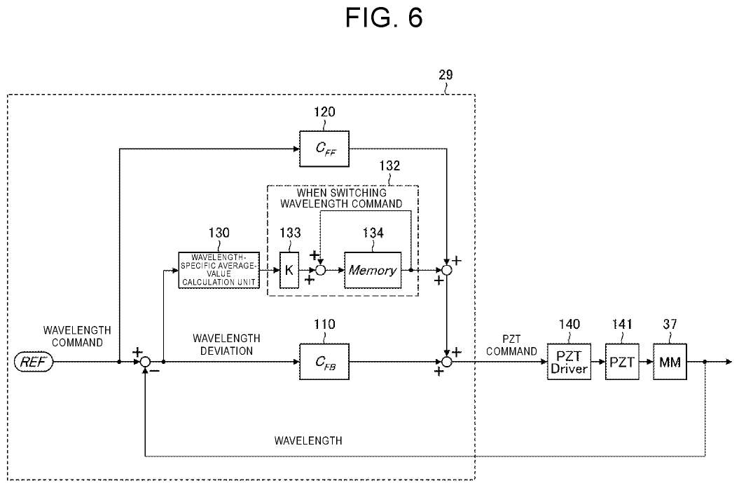

FIG. 6 is a control block diagram of the wavelength control executed by the processor 29. The control system for the wavelength control executed by the processor 29 includes a feedback control compensator (CFB) 110, a feedforward control compensator (CFF) 120, a wavelength-specific average-value calculation unit 130, and a learning controller 132. The learning controller 132 includes a learning control coefficient multiplier 133 that performs multiplication by a learning control coefficient (K), and a memory 134.

The processor 29 calculates the wavelength deviation from the difference between the wavelength measured by the wavelength monitor 37 and the wavelength command value, and performs feedback control by the feedback control compensator 110. The feedback control compensator 110 may be, for example, a compensator that performs PID (Proportional-Integral-Differential) control. The feedback control compensator 110 calculates a control value of the piezo command value (hereinafter, referred to as a “feedback control command value”) based on the input wavelength deviation. In FIG. 6, “MM” represents a monitor module including the wavelength monitor 37.

The feedforward control compensator 120 calculates a feedforward control command value as the piezo command value from the wavelength command value, for example, by using a gain coefficient with respect to the generated wavelength command. The processor 29 adds the feedforward control command value calculated by the feedforward control compensator 120 to the feedback control command value to perform the feedforward control.

The wavelength-specific average-value calculation unit 130 calculates the average value of the wavelength deviation for the wavelength command period for each of the long wavelength command and the short wavelength command in the rectangular cycle. The learning control by the learning controller 132 is executed separately for the long wavelength command and for the short wavelength command.

The processor 29 calculates the average value of the wavelength deviation for each wavelength calculated in the feedback control, and further calculates a value obtained by multiplying the average value for each wavelength by K. The calculated value is added to a value previously stored in the memory 134 (in a preceding cycle) as a learning control command value, and the learning control command value is updated.

The memory 134 stores the learning control command value for the long wavelength command and the learning control command value for the short wavelength command, respectively. Each of the learning control command values stored in the memory 134 corresponds to the piezo command correction amount for each target wavelength of the next cycle. The command output of the learning control adds the learning control command value stored in the memory 134 to the feedforward control command value at the timing at which the command transitions from the short wavelength to the long wavelength or from the long wavelength to the short wavelength, and performs the wavelength control.

When the number of pulses for the long wavelength command or the short wavelength command is “1”, wavelength-specific average-value calculation is not executed, and the wavelength deviation of each pulse is used as it is.

Thus, the processor 29 determines the piezoelectric command value by adding the output of the feedback control compensator 110 and the outputs of the feedforward control compensator 120 and the learning controller 132. The processor 29 outputs the determined piezo command value to the piezo driver 140, and drives the piezoelectric element 141 via the piezo driver 140.

The driving of the piezoelectric element 141 changes the wavelength of the pulse laser light 21 output from the laser device 11. The wavelength of the pulse laser light 21 is measured by the wavelength monitor 37, and the measurement value is fed back to the processor 29. The processor 29 obtains the difference (wavelength deviation) between the wavelength measurement value and the wavelength command value, and inputs the wavelength deviation to the feedback control compensator 110 and the wavelength-specific average-value calculation unit 130.

### 3.5 Effect

According to the first embodiment, it is possible to suppress the wavelength deviation and the interval error between two wavelength peaks caused by the hysteresis characteristic, the natural vibration, the thermal characteristic variation, and the like of the piezoelectric element 141 by performing the repetitive control for each rectangular cycle.

When the response of the piezoelectric element 141 sufficiently follows the rectangular cycle, it is preferable to perform learning control of the wavelength deviation in each wavelength command for each pulse. However, according to the first embodiment, even when the response of the piezoelectric element 141 cannot follow the rectangular cycle, by using the average value of the wavelength deviation for each wavelength, it is possible to control the interval between two wavelengths averaged for N slits just as the wavelength command.

The laser chamber 12 is an example of the “chamber” in the present disclosure. The wavelength selection mirror 34 is an example of the “optical element” and the “mirror” in the present disclosure. The movable holder 36 that rotates the mirror holder 38 is an example of the “rotation stage” in the present disclosure. The piezoelectric element unit 41 including the piezoelectric element 141 is an example of the “drive mechanism” in the present disclosure. The piezo command is an example of the “drive command” in the present disclosure, and the piezo command value is an example of the “drive command value” in the present disclosure.

### 4. Second Embodiment

### 4.1 Configuration

The configuration of the laser device 11 according to a second embodiment may be similar to that shown in FIG. 1.

### 4.2 Operation

The laser device 11 according to the second embodiment is different from that of the first embodiment in the operation including the control executed by the processor 29. In the following, the operation of the laser device 11 according to the second embodiment will be described in terms of differences from that of the first embodiment. In the second embodiment, in addition to the wavelength control for each rectangular cycle described in the first embodiment, wavelength control in a burst cycle TBu is further performed.

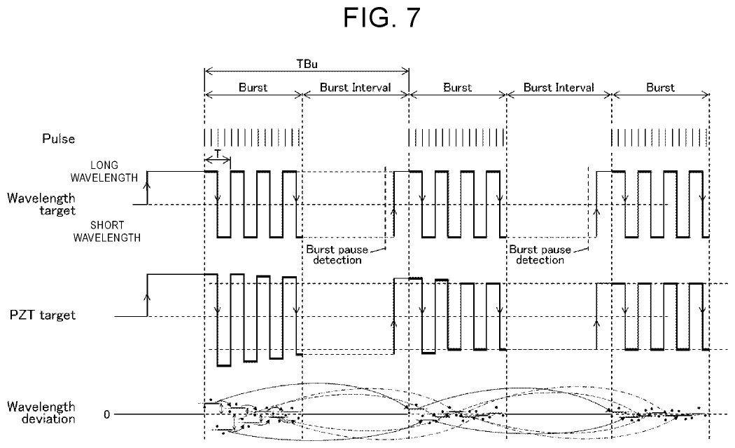

FIG. 7 is a timing chart showing an example of the operation of the laser device 11 according to the second embodiment.

At the start of the burst oscillation, the wavelength deviation different from that due to the rectangular cycle occurs. Therefore, with respect to the burst cycle TBu, the wavelength deviation or the average value of the wavelength deviation in each wavelength command is stored in the memory 134.

The processor 29 adjusts the piezo command value of the next burst period based on the wavelength deviation or the average value of the wavelength deviation stored for each wavelength.

In order to repeatedly perform the learning control for each burst cycle TBu, the learning control for each rectangular cycle is executed in advance, and only the wavelength deviation for each burst cycle TBu is to be detected while the wavelength command error of the rectangular cycle is suppressed.

At this time, since the wavelength deviation for each burst cycle TBu increases only at the time of the start of the driving (at the time of the start of the burst oscillation), it is preferable that the wavelength control by the learning control for each burst cycle TBu is applied only to a predetermined number Nf of pulses from the beginning of the burst. The predetermined number Nf of pulses may be, for example, 1 pulse or more and 20 pulses or less.

Further, it is preferable that the learning control coefficient for each burst cycle TBu is smaller than the learning control coefficient for each rectangular cycle so that the learning control for each burst cycle TBu does not interfere with the learning control for each rectangular cycle. The learning control coefficient for each rectangular cycle is an example of the “first coefficient” in the present disclosure, and the learning control coefficient for each burst cycle TBu is an example of the “second coefficient” in the present disclosure. The piezo command correction amount calculated by the learning control for each rectangular cycle is referred to as a rectangular cycle learning correction amount, and the piezo command correction amount calculated by the learning control for each burst cycle TBu is referred to as a burst cycle learning correction amount.

### 4.3 Description of Flowchart Showing Control Example

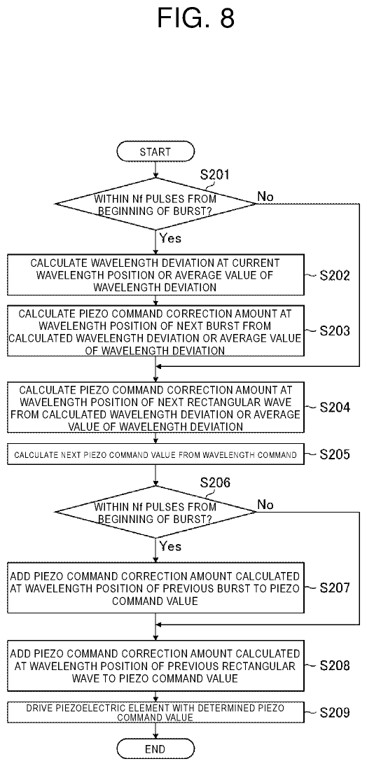

FIG. 8 is a flowchart showing a control example of the laser device 11 according to the second embodiment. When the flowchart of FIG. 8 is started, in step S201, the processor 29 determines whether or not it is within Nf pulse from the beginning of the burst.

When the determination result of step S201 is Yes, the processor 29 proceeds to step S202 and calculates the wavelength deviation at the present wavelength position or the average value of the wavelength deviation.

Then, in step S203, the processor 29 calculates the piezo command correction amount at the wavelength position of the next burst from the calculated wavelength deviation or the average value of the wavelength deviation.

After step S203 or when the determination result of step S201 is No, the processor 29 proceeds to step S204.

In step S204, the processor 29 calculates the piezo command correction amount at the wavelength position of the next rectangular wave from the calculated wavelength deviation or the average value of the wavelength deviation.

Then, in step S205, the processor 29 calculates the next piezo command value from the wavelength command.

In step S206, the processor 29 determines whether or not it is within Nf pulse from the beginning of the burst. When the determination result of step S206 is Yes, the processor 29 proceeds to step S207. In step S207, the processor 29 adds the piezo command correction amount (burst cycle learning correction amount) calculated at the wavelength position of the previous burst to the piezo command value. After step S207, the processor 29 proceeds to step S208.

On the other hand, when the determination result of step S206 is No, the processor 29 skips step S207 and proceeds to step S208.

In step S208, the processor 29 adds the piezo command correction amount (rectangular cycle learning correction amount) calculated at the wavelength position of the previous rectangular wave to the piezo command value.

Thereafter, in step S209, the processor 29 drives the piezoelectric element 141 with the determined piezo command value.

After step S209, the processor 29 ends the flowchart of FIG. 8. The processor 29 repeatedly executes the flowchart of FIG. 8 during the period of the burst operation.

Thus, the processor 29 performs the wavelength control for correcting the piezo command value of the subsequent cycle in which the target wavelength is the same for each rectangular cycle, and further performs the wavelength control for correcting the piezo command value of a subsequent second burst cycle based on the wavelength deviation in a preceding first burst cycle for each burst cycle TBu. The wavelength control for correcting the piezo command value using the rectangular cycle learning correction amount for each rectangular cycle is an example of the “first wavelength control” in the present disclosure. The wavelength control for correcting the piezo command value using the burst cycle learning correction amount for each burst cycle TBu is an example of the “second wavelength control” in the present disclosure.

### 4.4 Effect

According to the second embodiment, it is possible to suppress the wavelength deviation and the interval error between two wavelength peaks that occur at the start of the burst oscillation of the pulse laser light 21 by repeatedly performing control for each burst cycle in addition to the control for each rectangular cycle.

### 5. Electronic Device Manufacturing Method

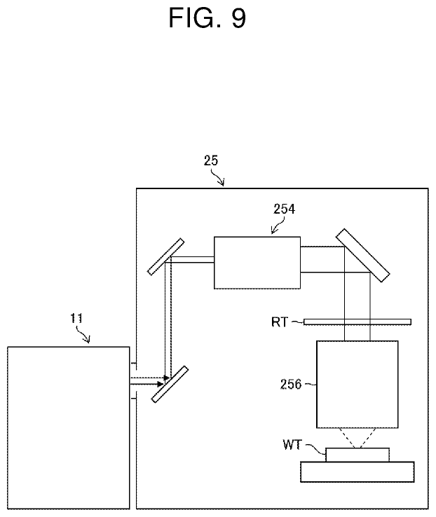

FIG. 9 schematically shows a configuration example of the exposure apparatus 25. The exposure apparatus 25 includes an illumination optical system 254 and a projection optical system 256. The illumination optical system 254 illuminates a reticle pattern of a reticle (not shown) arranged on a reticle stage RT with laser light incident from the laser device 11. The projection optical system 256 causes the laser light transmitted through the reticle to be imaged as being reduced and projected on a workpiece (not shown) arranged on a workpiece table WT. The workpiece is a photosensitive substrate such as a semiconductor wafer on which photoresist is applied.

The exposure apparatus 25 synchronously translates the reticle stage RT and the workpiece table WT to expose the workpiece to the laser light reflecting the reticle pattern. After the reticle pattern is transferred onto the semiconductor wafer by the exposure process described above, a semiconductor device can be manufactured through a plurality of processes. The semiconductor device is an example of the “electronic device” in the present disclosure.

### 6. Others

The description above is intended to be illustrative and the present disclosure is not limited thereto. Therefore, it would be obvious to those skilled in the art that various modifications to the embodiments of the present disclosure would be possible without departing from the spirit and the scope of the appended claims. Further, it would be also obvious to those skilled in the art that embodiments of the present disclosure would be appropriately combined.

The terms used throughout the present specification and the appended claims should be interpreted as non-limiting terms unless clearly described. For example, terms such as “comprise”, “include”, “have”, and “contain” should not be interpreted to be exclusive of other structural elements. Further, indefinite articles “a/an” described in the present specification and the appended claims should be interpreted to mean “at least one” or “one or more.” Further, “at least one of A, B, and C” should be interpreted to mean any of A, B, C, A+ side or, A+C, B+C, and A+B+C as well as to include combinations of any thereof and any other than A, B, and C.

What is claimed is:

1. A laser device comprising:
an oscillator configured to output pulse laser light in a burst form;
a wavelength monitor configured to measure a center wavelength of the pulse laser light output from the oscillator; and
a processor,
the oscillator including:
a chamber including discharge electrodes configured to apply a voltage to a laser gas in the chamber;
an optical element arranged on an optical path of the pulse laser light;
a rotation stage on which the optical element is mounted;
a drive mechanism configured to rotate the optical element by driving the rotation stage;
a grating on which the pulse laser light transmitted through or reflected by the optical element is incident; and
an output coupling mirror configured to output the pulse laser light,
the processor being configured to periodically switch a target value of the center wavelength of the pulse laser light between a first target value and a second target value different from the first target value, control the center wavelength, based on the target value and a measurement value of the center wavelength measured by the wavelength monitor, by outputting a drive command to the drive mechanism to change an incident angle of the pulse laser light on the grating, and correct a drive command value of the drive mechanism for outputting the pulse laser light with the same target value in a subsequent cycle based on a deviation between the measurement value of the center wavelength and the target value.

2. The laser device according to claim 1,
wherein each of the pulse laser light with the first target value and the pulse laser light with the second target value is continuously output in a plurality of pulses, and
a first pulse number for which the pulse laser light with the first target value is continuous is equal to a second pulse number for which the pulse laser light with the second target value is continuous.

3. The laser device according to claim 1,
wherein, when n is an integer of 1 or more, the processor corrects, based on the measurement value of the center wavelength of an n-th pulse in a first cycle in a wavelength change cycle in which the target value is periodically switched, the drive command value of an n-th pulse in a subsequent second cycle.

4. The laser device according to claim 1,
wherein each of the pulse laser light with the first target value and the pulse laser light with the second target value is continuously output in a plurality of pulses, and
the processor corrects, based on an average value of the deviation in a first pulse number for which the first target value is continuous in a first cycle in a wavelength change cycle in which the target value is periodically switched, the drive command value for pulses with the first target value in a subsequent second cycle, and corrects, based on an average value of the deviation in a second pulse number for which the second target value is continuous in the first cycle, the drive command value for pulses with the second target value in the subsequent second cycle.

5. The laser device according to claim 1,
wherein the processor corrects the drive command value by an amount corresponding to a value obtained by multiplying the deviation or an average value of the deviation by a coefficient smaller than 1.

6. The laser device according to claim 5,
wherein the coefficient is 0.01 or more and 0.5 or less.

7. The laser device according to claim 1,
wherein the processor performs for each wavelength change cycle in which the target value is periodically switched, based on the deviation in a first cycle, first wavelength control for correcting the drive command value in a subsequent second cycle, and further performs for each burst cycle, based on the deviation in a first burst cycle, second wavelength control for correcting the drive command value in a subsequent second burst cycle.

8. The laser device according to claim 7,
wherein the second wavelength control is applied only for a predetermined pulse number of pulses from burst beginning in the burst cycle.

9. The laser device according to claim 8,
wherein the predetermined number of pulses is 20 or less.

10. The laser device according to claim 7,
wherein the first wavelength control includes correcting the drive command value by an amount corresponding to a value obtained by multiplying the deviation or an average value of the deviation by a first coefficient smaller than 1, and
the second wavelength control includes correcting the drive command value by an amount corresponding to a value obtained by multiplying the deviation or the average value of the deviation by a second coefficient smaller than the first coefficient.

11. The laser device according to claim 1,
wherein the optical element is a mirror.

12. The laser device according to claim 1,
wherein the optical element is a prism.

13. The laser device according to claim 1,
wherein the drive mechanism includes a piezoelectric element.

14. The laser device according to claim 1,
wherein the processor includes:
a feedback control compensator configured to calculate a feedback control command value based on the deviation between the measurement value of the center wavelength and the target value;
a feedforward control compensator configured to calculate a feedforward control command value as the drive command value based on the target value and add the feedforward control command value to the feedback control command value; and
a learning controller configured to update a learning control command value by adding a value obtained by multiplying the deviation or an average value of the deviation for each wavelength of the target value by a coefficient smaller than 1 to a value stored in a memory in a preceding cycle as the learning control command value, for each wavelength change cycle in which the target value is periodically switched, and
the learning control command value for each of the wavelengths stored in the memory is added to the feedforward control command value at a timing of switching the target value.

15. An electronic device manufacturing method, comprising:
generating laser light using a laser device;
outputting the laser light to an exposure apparatus; and
exposing a photosensitive substrate to the laser light in the exposure apparatus to manufacture an electronic device,
the laser device including:
an oscillator configured to output pulse laser light in a burst form;
a wavelength monitor configured to measure a center wavelength of the pulse laser light output from the oscillator; and
a processor,
the oscillator including:
a chamber including discharge electrodes configured to apply a voltage to a laser gas in the chamber;
an optical element arranged on an optical path of the pulse laser light;
a rotation stage on which the optical element is mounted;
a drive mechanism configured to rotate the optical element by driving the rotation stage;
a grating on which the pulse laser light transmitted through or reflected by the optical element is incident; and
an output coupling mirror configured to output the pulse laser light,
the processor being configured to periodically switch a target value of the center wavelength of the pulse laser light between a first target value and a second target value different from the first target value, control the center wavelength, based on the target value and a measurement value of the center wavelength measured by the wavelength monitor, by outputting a drive command to the drive mechanism to change an incident angle of the pulse laser light on the grating, and correct a drive command value of the drive mechanism for outputting the pulse laser light with the same target value in a subsequent cycle based on a deviation between the measurement value of the center wavelength and the target value.
